(19) United States
(12) Patent Application Publication
(10) Pub. No.: US 2008/0242272 A1
(43) Pub. Date: Oct. 2, 2008

(54) SYSTEM AND METHOD FOR SEARCH ENGINE MARKETERS TO IMPLEMENT BEHAVIORAL TARGETING

(76) Inventors: Devesh Patel, Cupertino, CA (US); Soren Riise, Ruislip (GB); Martin Barnes, Essex (GB); Bruce Campbell, Hertfordshire (GB)

Correspondence Address: BRINKS HOFER GILSON & LIONE / YAHOO! OVERTURE, P.O. BOX 10395, CHICAGO, IL, 60610, US

(21) Appl. No.: 11/691,629

(22) Filed: Mar. 27, 2007

(51) Int. Cl. H04Q 7/38

(52) U.S. Cl. 455/414.1

(57) ABSTRACT

A system for providing profile information of a user to at least one subscriber includes a processor and a memory unit having a set of processor executable instructions. The processor executable instructions configuring the processor to: collect profile information from the user, the profile information being generated as the user interacts with a host web portal, assign an anonymous user identification to the profile information collected from the user and publish the profile information having the anonymous user identification to the at least one subscriber. The processor executable instructions can also configure the processor to receive at least one bid from the at least one subscriber to present a targeted advertisement to the user, determine the most desirable bid from the at least one subscriber and present the targeted advertisement to the user from the at least one subscriber having the most desirable bid.

### BACKGROUND

1. Field of the Invention

The present invention relates to systems and methods for providing profile information of a user generated as the user interacts with a host web portal to a third party.

2. Description of the Known Technology

Internet portal providers such as American Online, Google, the Microsoft Network, and Yahoo! capture user activity data generated by users who interact with their web portals. These web portal providers use this user activity data to provide targeted advertisements to the user as the user interacts with the web portal. By providing targeting advertisements to the user as the user interacts with the web portal, the web portal provider increases the relevance of the advertising and increases its chances that user will click on the provided advertisement. Better known as a pay-per-click (“PPC”) system, everytime the user clicks on an advertisement provided to the user by the web portal provider, the web portal provider is typically paid by the advertiser. Therefore, it is in the financial interest of the web portal provider to provide advertisements to users that the users are likely to click. By so doing, more users will click on more advertisements, thereby generating increased revenue for the web portal provider.

While this system has been very successful, there are opportunities for improvements. For example, this system and method requires that the web portal provider rely on its own algorithms for determining which advertisements would likely induce the user to click on those advertisements, without any input from the advertiser. Additionally, web portal providers do not share captured user activity with each other, limiting the amount of data available for the web portal provider to utilize in determining the most likely targeted advertisement that the user will click on. Therefore, there is a need for an improved system and method for providing targeted advertising.

### SUMMARY

In satisfying the above need, the present invention provides a system and method for providing profile information generated by a user to one or more subscribers. The system and method of the present invention accomplishes these ends by collecting profile information generated by the user as the user interacts with a host web portal. Afterwords, an anonymous user identification is assigned to the profile information collected from the user. Finally, the profile information having the anonymous user identification is published to the subscribers. Profile information may be published to the subscribers based on a category previously identified by the subscribers. Furthermore, the act of publishing the profile information to the subscribers may be triggered by an event. This event is typically an action taken by the user as the user interacts with the host web portal.

Once the subscribers receive the user profile information, the subscribers can then utilize their own algarithms in determining if the subscribers would like to have a targeted advertisement provided to the user by the posed web portal. The system and method will receive these multiple bids from the subscribers and determine which bid is the most desirable. Thereafter, the system and method will provide a targeted advertisement to the user from the subscriber having the most desirable bid. Generally, this targeted advertisement is any well known web based advertisement such as including a pop up advertisement, a banner advertisement, email or out-of-band inclusion of search listings.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a system for providing profile information of a user to at least one subscriber;

FIG. 2 is a flow chart illustrating a method for providing information of a user to at least one subscriber;

FIG. 3 is a flow chart illustrating a method for providing profile information of a user to at least on subscriber based upon the occurrence of an event;

FIG. 4 is a flow chart illustrating a method for providing profile information of a user to a subscriber, the profile information being in a category identified by the subscriber; and

FIG. 5 is a flow chart illustrating a method for receiving bids from subscribers for presenting a targeted advertisement to a user based upon the users profile information.

### DETAILED DESCRIPTION

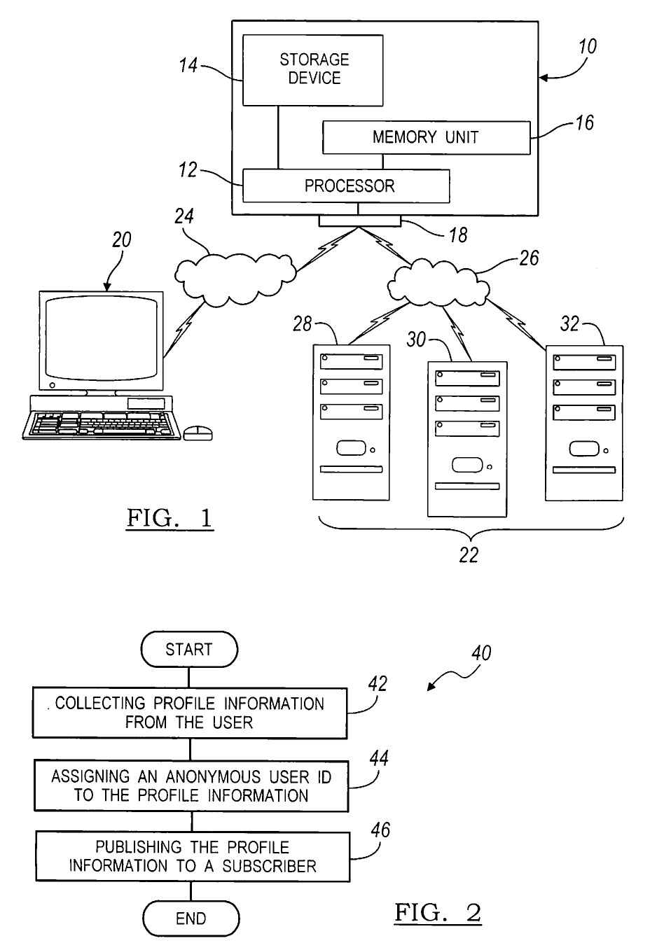

Referring to FIG. 1, a system 10 for providing profile information of a user 20 to at least one subscriber 22 as well as receiving bids from the subscribers 22 to provide targeted advertising to the user 20 is shown. The system 10 includes a processor 12 in communication with a storage device 14, a memory unit 16 and a network interface 18. As will be described later in this detailed description, the memory unit 16 contains a set of instructions for configuring the processor 12 to provide profile information of the user 20 to the subscribers 22 and to receive bids from subscribers 22 to provide targeted advertisements to the user 20.

The network interface 18 allows that the processor 12 of the system 10 to communicate with a user 20 and subscribers 22 via networks 24, 26, respectively. Generally, the user 20 is a general purpose personal computer capable of accessing a web portal provided by the system 10. For example, the web portal provided by the system 10 may be a web portal similar to those offered by Yahoo! Inc. of Sunnyvale, Calif. Typically, the network 24 in which the user interacts with the system 10 is the Internet, but the network 24 may be a closed network or a combination of one or more closed networks and the Internet.

The subscribers 22 are, by way of example, made up of three subscribers 28, 30, 32. It should be understood, that any number of subscribers can interact with the system 10 via the network 26. Similar to the network 24, the network 26 is generally the Internet but maybe a closed network or one or more closed networks operating in conjunction with the Internet.

Referring to FIGS. 1 and 2, a method 40 for providing profile information of the user 20 to the subscribers 22 is shown. In its simplest form, the system 10 collects profile information from the user 20 as shown in step 42. This profile information is generated as the user interacts with the web portal provided by the system 10. For example, if the user 20 utilizes the web portal provided by the system 10 to perform a variety of searches regarding automobiles, the system 10 will collect the substantive search data in order to create profile information according to the user 20.

As shown in step 44, the profile information regarding the user 20 is assigned an anonymous user identification (“ID”). By assigning an anonymous user ID to the profile information, subscribers 22 who are provided the user's profile information will not be able to identify the user 20 without first interacting with the system 10. Two advantages are realized by providing an anonymous user ID to the profile information: first, the privacy by the user 20 is not jeopardized by the system 10, and second, the subscribers 22 have no other option but to work with the system 10 in order to contact the user 20. By so doing, the owners of the system 10 can request payment for their services.

Finally, as shown in step 46, the system 10 publishes the profile information of the user 20 to the subscribers 22. The data is published to the subscriber using any existing transfer mechanism such as HTTP/HTTPS, Email. Datagrams or other similar TCP/UDP internet protocol, or by file transfer such as FTP or by CD/DVD or other such commonly available media. The Data Transfer should in a preferred implementation use data encryption to prevent interception and modification. Once receiving this information from the system 10, the subscribers 22 can then perform their own analysis of the profile information of the user 20 in determining which advertisements the subscribers 22 would like to present to the user 20. As previously stated, since the user 20 is cloaked with anonymous user ID, the subscribers 22 can only contact the user 20 via the system 10. As will later be described in this detailed description section, a bidding process may be utilized by the system 10 in order to provide a targeted advertisement to the user 20 from the subscriber 22 who places the most desirable bid.

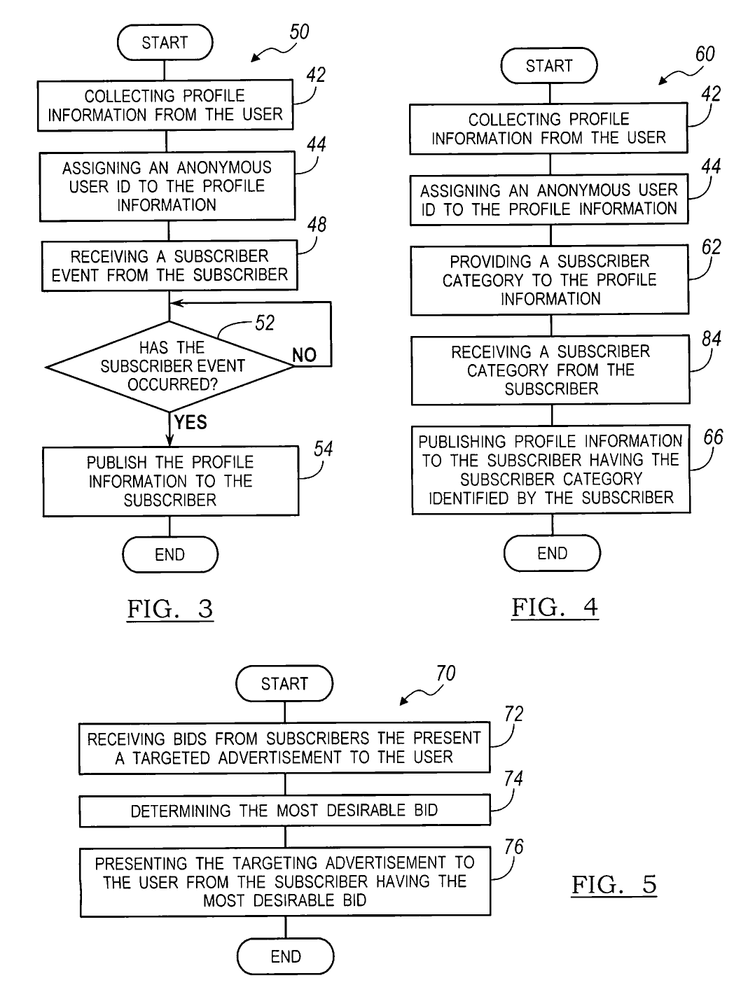

Referring to FIGS. 1 and 3, another method 50 executed by the processor 12 of the system 10 is shown. Steps 42 and 44 are similar to those shown in the method 40 of FIG. 2. The method 50 differs from the method 40 of FIG. 2 in that the method 50 waits for certain events to occur before publishing the profile information of the user 20 to the subscribers 22. An event triggering the system 10 to publish the profile information 20 to the subscriber 22 is generally an event initiated by the user 20. For example, such an event may be the user 20 searching for a specific item only offered by the subscriber. Other examples include the user 20 clicking on a competitors web site.

Returning to the method 50 the system 10 receives from one or more of the subscribers 22 an event as shown in step 48. In step 52, the system 10 makes a determination if the subscriber event has occurred. If the subscriber event has occurred, the profile information of the user 20 is published to one or more of the subscribers 22 as shown in step 54.

Referring to FIGS. 1 and 4, another method 60 executed by the processor 12 of the system 10 is shown. Steps 42 and 44 of the method 60 are similar to those previously described in the method 40 of FIG. 2. The method 60 differs from the method 40 in that the system 10 categorizes the profile information of the user 20. For example, if the profile information generated by the user 20 relates to the purchase of an automobile, the system 10 will categorize the profile information as a potential automobile purchase. Of course, it should be understood the same profile information may receive multiply categories. For example, not only can the profile information for the above category relate to a general automobile purchase category, but may also relate to specific make and model of an automobile.

Returning to the method 60, in step 62, the system 10 provides a subscriber category to the profile information generated by the user 20. In step 64, the system 10 receives from the subscribers 22 subscriber categories. By receiving these subscriber categories, the system 10 can determine profile information desired by the subscribers 22. Thereafter, as shown in step 66, the system 10 publishes profile information to the subscribers 22; the profile information being of the category previously identified by the subscribers 22.

Referring to FIGS. 1 and 5 a method 70 of receiving bids to provide targeted advertising to the user 20 is shown. As described previously, the subscribers 22 are provided with the profile information of the user 20. The subscribers 22 may then use their own algorithms to determine if they would like to target the user 20 with a targeted advertisement. Once the subscribers 22 have determined that they would like to target the user 20 with the targeted advertisement, the subscribers 22 provide competing bids to the system 10.

As shown in step 72, the system 10 receives bids from the subscribers 22 to present a targeted advertisement to the user 20. In step 74, the system 10 determines the most desirable bid from the subscribers 22. Typically, the most desirable bid is the highest monetary bid from the subscribers 22. Of course, the system 10 may utilize other factors in determining which bid is the most desirable.

In step 76, once the system 10 has determined the most desirable bid, the system 10 presents a targeted advertisement to the user 20 from the subscriber 22 having the most desirable bid. Typically, this targeted advertisement is provided to the user 22 when the user interacts with the web portal provided by the system 10. Examples of this can include pop up advertisements, email, search results, or banner advertisements on the web portal provided by the system 10 as the user interacts with the web portal.

It should be understood that the methods 40, 50, 60 and 70 can be used in combination with each other. For example, the method 50 can be combined with the methods 60 and 70 to yield a method that would publish profile information to the subscribers 22 of a certain category when a certain event occurs.

As a person skilled in the art will readily appreciate, the above description is meant as an illustration of implementation of the principles of this invention. This description is not intended to limit the scope or application of this invention in that the invention is susceptible to modification, variation and change, without departing from the spirit of this invention, as defined in the following claims.

1. A method for providing profile information of a user to at least one subscriber, the method comprising the steps of:
collecting profile information from the user, the profile information being generated as the user interacts with a host web portal;
assigning an anonymous user identification to the profile information collected from the user; and
publishing the profile information having the anonymous user identification to the at least one subscriber.

2. The method of claim 1, the method further comprising the step of changing the anonymous user identification after a specified period has elapsed.

3. The method of claim 2, wherein the specified period is one month.

4. The method of claim 1, further comprising the step of providing at least one subscriber category to the profile information.

5. The method of claim 4, further comprising the steps of:
receiving the at least one subscriber category from the subscriber; and
publishing the profile information having the at least one subscriber category to the at least one subscriber.

6. The method of claim 1, further comprising the steps of:
receiving at least one subscriber event from the at least one subscriber, the least one subscriber event being a specific action taken by the user as the user interacts with the host web portal; and
publishing the profile information to the at least one subscriber when the at least one subscriber event has occurred.

7. The method of claim 1, further comprising the steps of:
receiving at least one bid from the at least one subscriber to present a targeted advertisement to the user;
determining the most desirable bid from the at least one subscriber; and
presenting the targeted advertisement to the user from the at least one subscriber having the most desirable bid.

8. A system for providing profile information of a user to at least one subscriber, the system comprising:
a processor;
a memory unit having a set of processor executable instructions, the processor executable instructions configuring the processor to:
collect profile information from the user, the profile information being generated as the user interacts with a host web portal;
assign an anonymous user identification to the profile information collected from the user; and
publish the profile information having the anonymous user identification to the at least one subscriber.

9. The system of claim 8, wherein the processor executable instructions further configure the processor to change the anonymous user identification after a specified period has elapsed.

10. The system of claim 9, wherein the specified period is one month.

11. The system of claim 8, wherein the processor executable instructions further configure the processor to provide at least one subscriber category to the profile information.

12. The system of claim 8, wherein the processor executable instructions further configure the processor to:
receive the at least one subscriber category from the subscriber; and
publish the profile information having the at least one subscriber category to the at least one subscriber.

13. The system of claim 8, wherein the processor executable instructions further configure the processor to:
receive at least one subscriber event from the at least one subscriber, the least one subscriber event being a specific action taken by the user as the user interacts with the host web portal; and
publish the profile information to the at least one subscriber when the at least one subscriber event has occurred.

14. The system of claim 8, wherein the processor executable instructions further configure the processor to:
receive at least one bid from the at least one subscriber to present a targeted advertisement to the user;
determine the most desirable bid from the at least one subscriber; and
present the targeted advertisement to the user from the at least one subscriber having the most desirable bid.

15. The system of claim 8, further comprising a storage device for storing the profile information.

16. In a computer readable storage medium having stored therein instructions executable by a programmed processor for providing profile information of a user to at least one subscriber, the storage medium comprising instructions for:
collecting profile information from the user, the profile information being generated as the user interacts with a host web portal;
assigning an anonymous user identification to the profile information collected from the user; and
publishing the profile information having the anonymous user identification to the at least one subscriber.

17. The computer readable storage medium of claim 16 further comprising processor executable instructions for changing the anonymous user identification after a specified period has elapsed.

18. The computer readable storage medium of claim 16, wherein the specified period is one month.

19. The computer readable storage medium of claim 16 further comprising processor executable instructions for providing at least one subscriber category to the profile information.

20. The computer readable storage medium of claim 16 further comprising processor executable instructions for:
receiving the at least one subscriber category from the subscriber; and
publishing the profile information having the at least one subscriber category to the at least one subscriber.

21. The computer readable storage medium of claim 16 further comprising processor executable instructions for:
receiving at least one subscriber event from the at least one subscriber, the least one subscriber event being a specific action taken by the user as the user interacts with the host web portal; and
publishing the profile information to the at least one subscriber when the at least one subscriber event has occurred.

22. The computer readable storage medium of claim 16 further comprising processor executable instructions for:
receiving at least one bid from the at least one subscriber to present a targeted advertisement to the user;
determining the most desirable bid from the at least one subscriber; and
presenting the targeted advertisement to the user from the at least one subscriber having the most desirable bid.
